(19) United States
(12) Patent Application Publication
(10) Pub. No.: US 2008/0281978 A1
(43) Pub. Date: Nov. 13, 2008

(54) METHODS FOR UTILIZING MULTIPLE TUNNELS WITHIN A COMMUNICATION NETWORK

(75) Inventors: Dah-Lain Almon Tang, Naperville, IL (US); Shreesha Ramanna, Vernon Hills, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/102,069

(22) Filed: Apr. 14, 2008

Related U.S. Application Data
(60) Provisional application No. 60/917,236, filed on May 10, 2007.

(51) Int. Cl. G06F 15/16

(52) U.S. Cl. 709/232

(57) ABSTRACT

Various embodiments are described, some of which may be able to better support real-time services during mobility events in communication networks. In general in these embodiments, multiple tunnels are established via different network nodes within the communication network to support data transfer in both a forward direction to an access terminal (AT) and a reverse direction from the AT. Data transfer in the forward direction is supported for a period of time via a first tunnel (140, 150) of the multiple tunnels, while data transfer in the reverse direction is supported via a second, different tunnel (160) during the same period of time.

### REFERENCE(S) TO RELATED APPLICATION(S)

The present application claims priority from a provisional application, Ser. No. 60/917236, entitled “METHODS FOR UTILIZING MULTIPLE TUNNELS WITHIN A COMMUNICATION NETWORK,” filed May 10, 2007, which is commonly owned and incorporated herein by reference in its entirety.

### FIELD OF THE INVENTION

The present invention relates generally to communication systems and, in particular, to using multiple tunnels within a communication network.

### BACKGROUND OF THE INVENTION

Various wireless communication technologies are being developed to support real-time services such as VoIP (voice over internet protocol), Video Telephony, voice and video streaming, etc. Providing such services to mobile devices creates many challenges, particularly for devices that are moving through a communication system and handing off from one base station (BS) or access network (AN) to the next. Typically, a data tunnels are set up from a serving BS/AN to a data gateway device to handle bearer traffic to and from the mobile device. This path may comprise a number of network nodes and/or devices that serve as anchors along this path. A series of tunnels may be established between the anchors to provide the bearer path. As the mobile device hands off across the system, the bearer path must be modified by establishing new tunnels and anchors to follow the mobile. Such data route switching may introduce added latency and/or disruption to real-time services. Thus, new techniques able to better support real-time services during mobility events are clearly desirable for advancing the art.

### BRIEF DESCRIPTION OF THE DRAWINGS

FIG. 1 is a messaging flow diagram depicting the use of multiple tunnels, in accordance with various embodiments of the present invention.

FIG. 2 is a block diagram depiction of a possible tunneling structure between functional elements in a wireless communication system, in accordance with more specific embodiments of the present invention.

FIG. 3 is a block diagram depiction of a possible tunneling structure between functional elements in a wireless communication system, in accordance with more specific embodiments of the present invention.

FIG. 4 is a block diagram depiction of a possible tunneling structure between functional elements in a wireless communication system, in accordance with more specific embodiments of the present invention.

FIG. 5 is a block diagram depiction of a possible tunneling structure between functional elements in a wireless communication system, in accordance with more specific embodiments of the present invention.

FIG. 6 is a block diagram depiction of a possible tunneling structure between functional elements in a wireless communication system, in accordance with more specific embodiments of the present invention.

FIG. 7 is a messaging flow diagram depicting the use of multiple tunnels, in accordance with more specific embodiments of the present invention.

FIG. 8 is a messaging flow diagram depicting the use of multiple tunnels, in accordance with more specific embodiments of the present invention.

FIG. 9 is a messaging flow diagram depicting the use of multiple tunnels, in accordance with more specific embodiments of the present invention.

FIG. 10 is a messaging flow diagram depicting the use of multiple tunnels, in accordance with more specific embodiments of the present invention.

FIG. 11 is a messaging flow diagram depicting the use of multiple tunnels, in accordance with more specific embodiments of the present invention.

FIG. 12 is a messaging flow diagram depicting the use of multiple tunnels, in accordance with more specific embodiments of the present invention.

FIG. 13 is a messaging flow diagram depicting the use of multiple tunnels, in accordance with more specific embodiments of the present invention.

FIG. 14 is a messaging flow diagram depicting the use of multiple tunnels, in accordance with more specific embodiments of the present invention.

FIG. 15 is a block diagram depiction of a GRE header with modified key field, in accordance with more specific embodiments of the present invention.

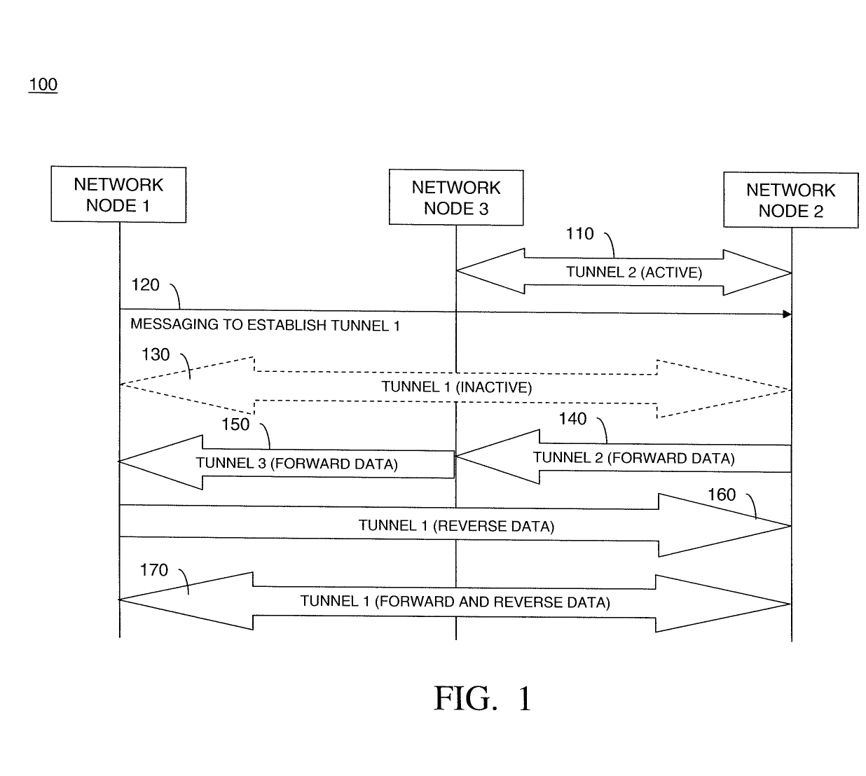

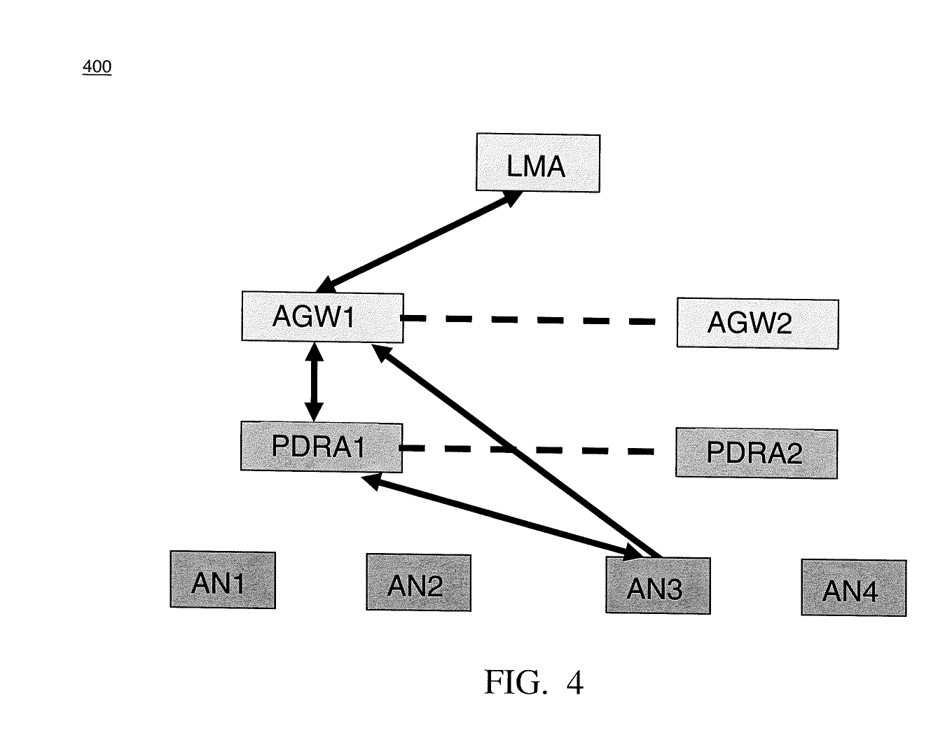

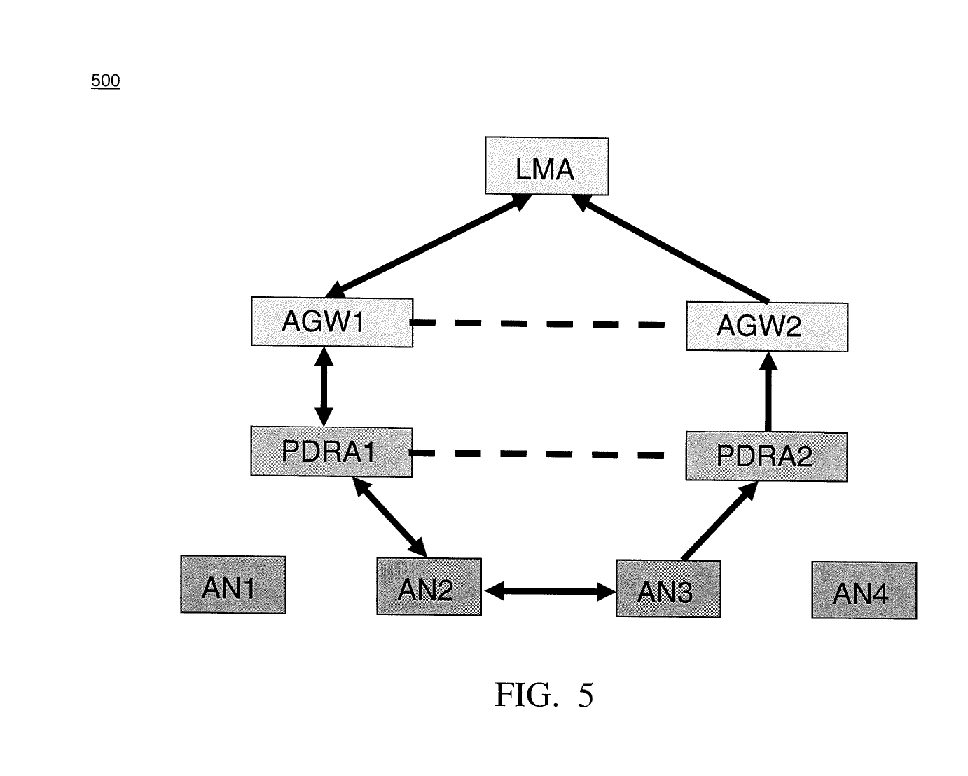

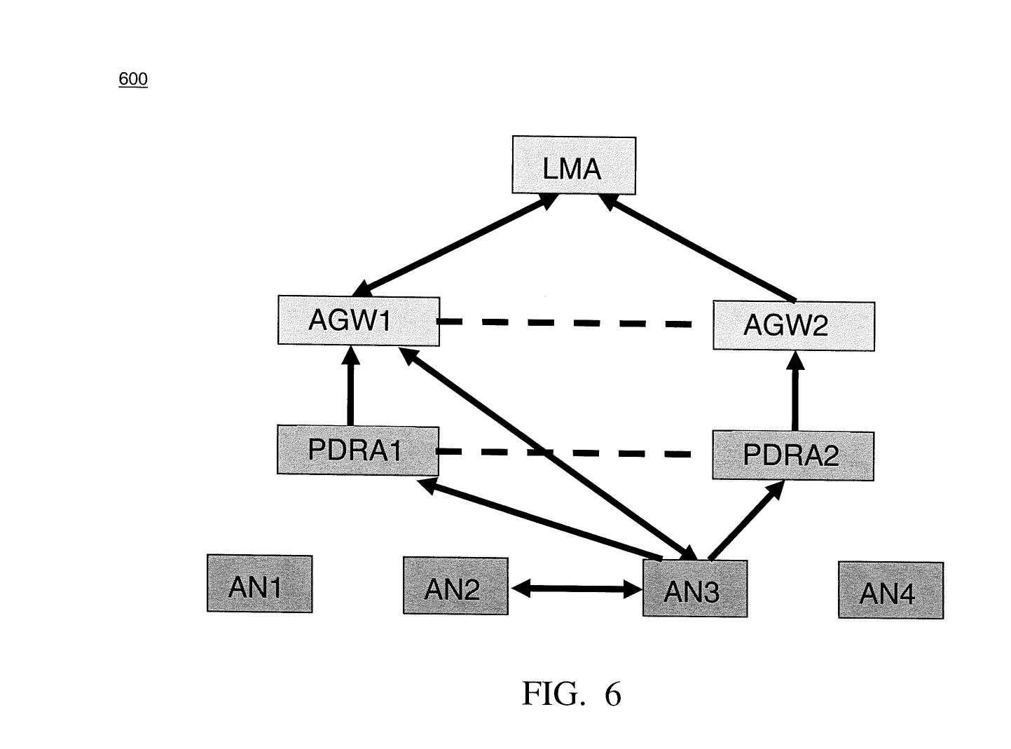

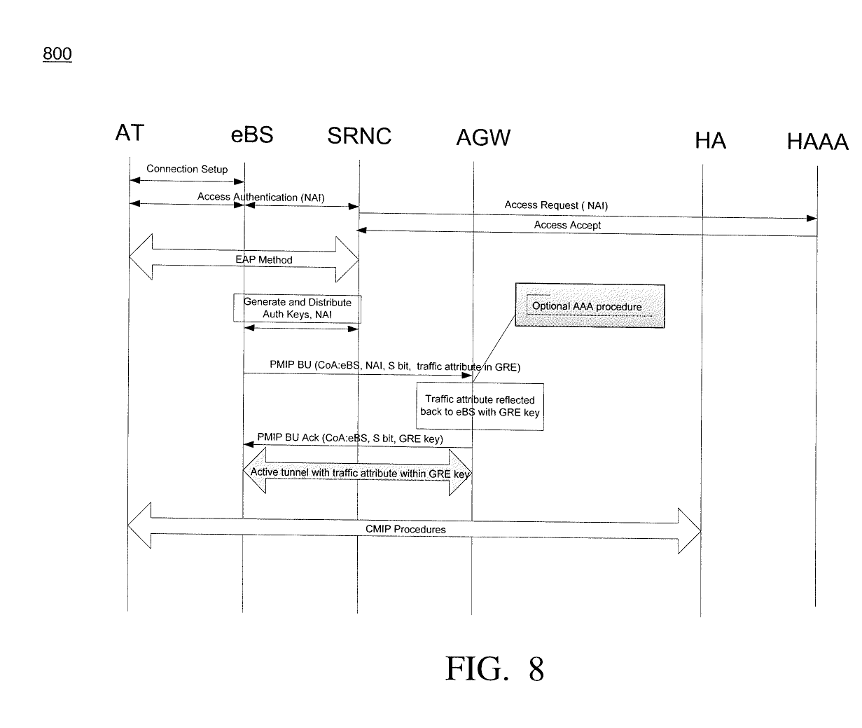

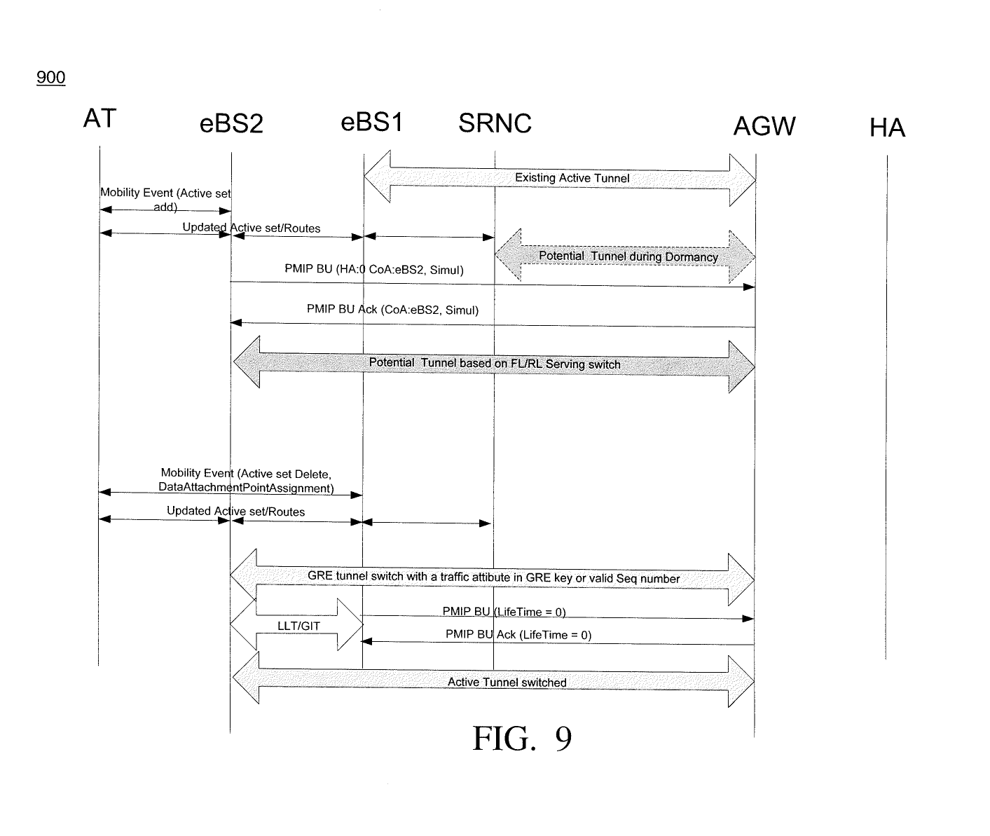

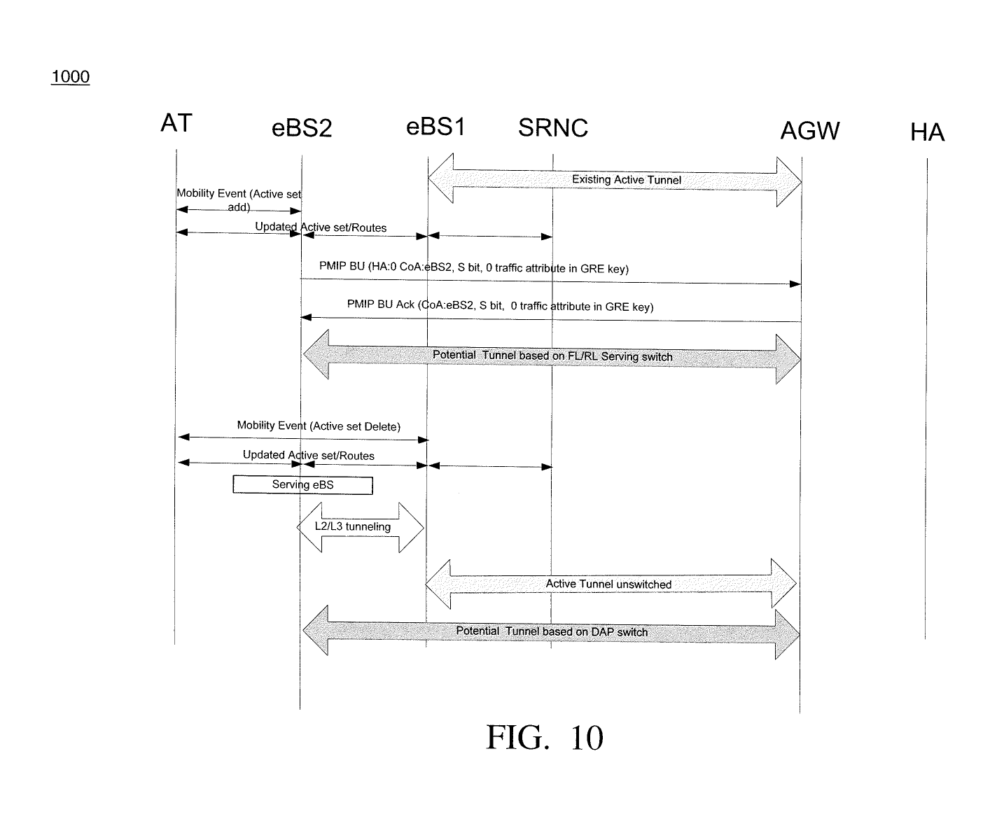

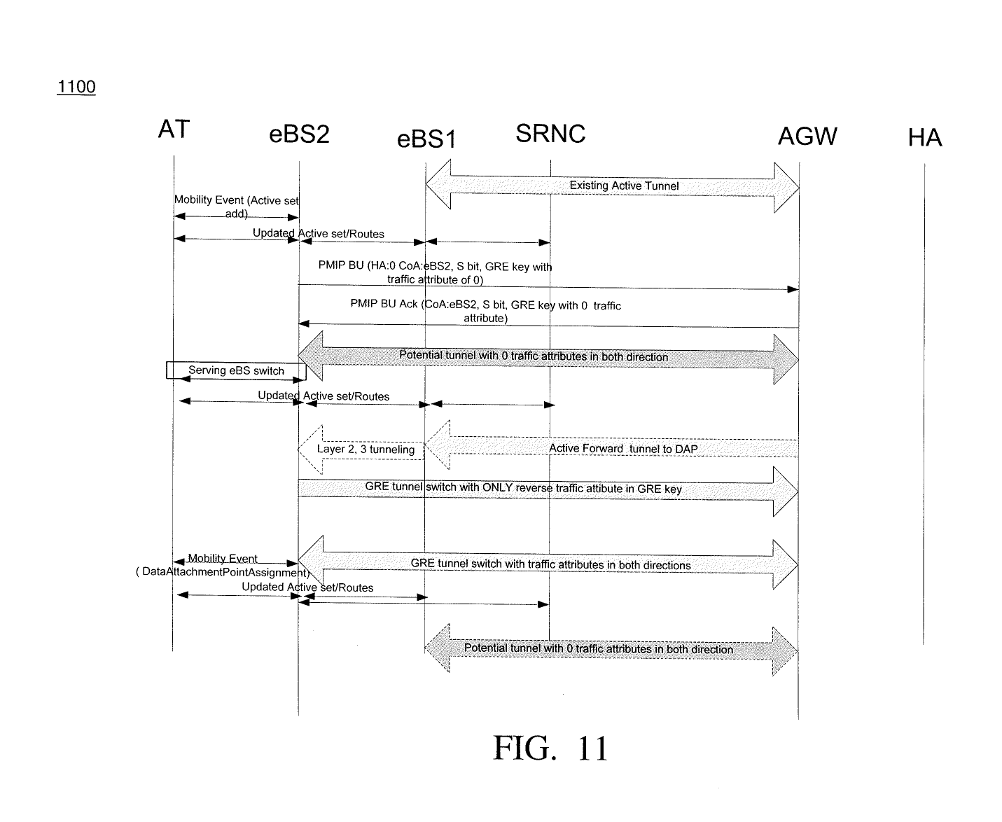

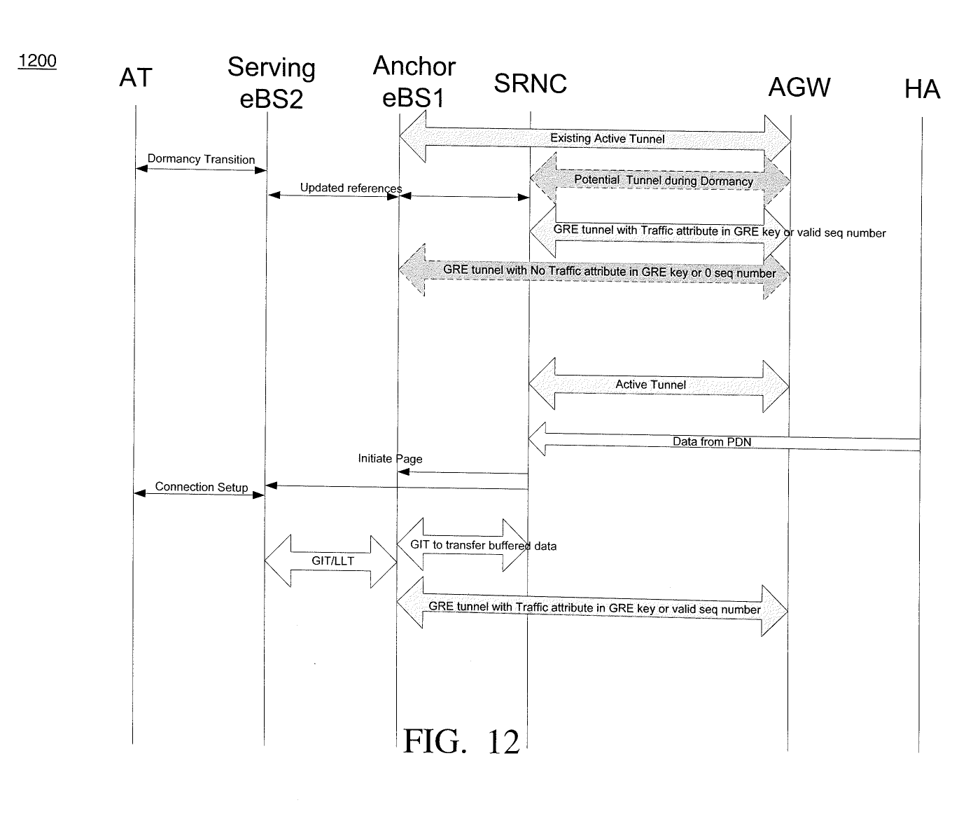

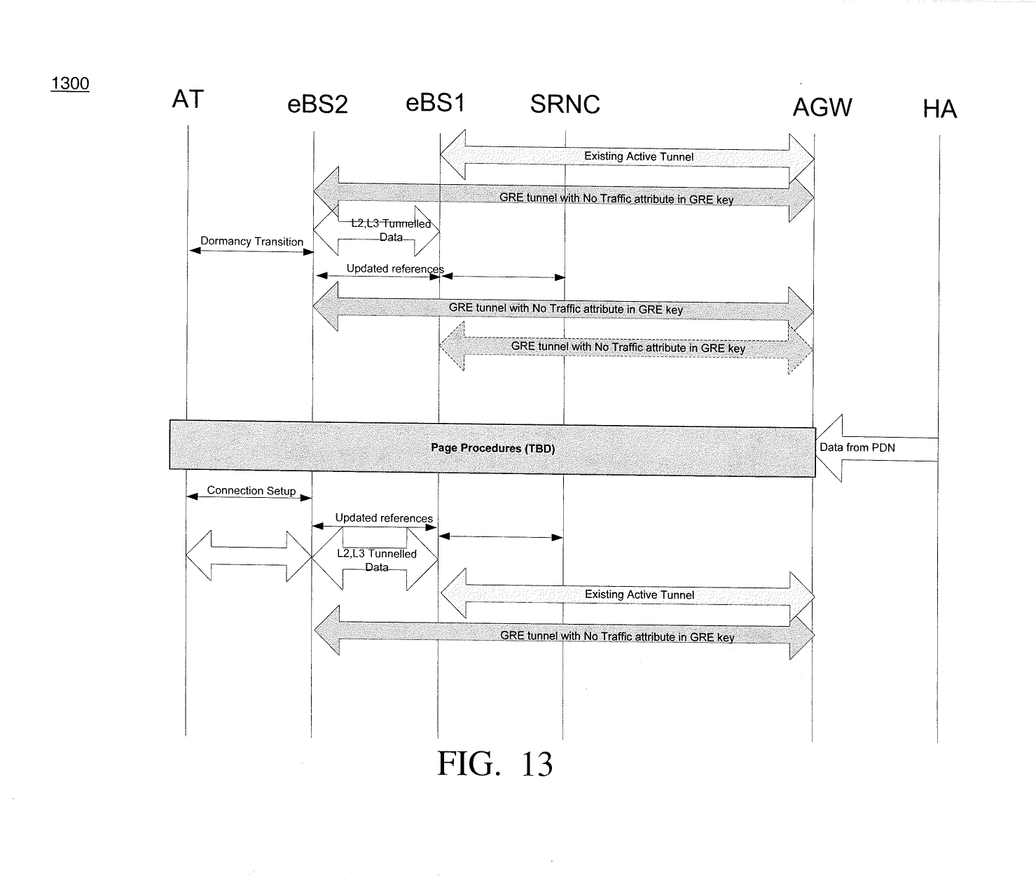

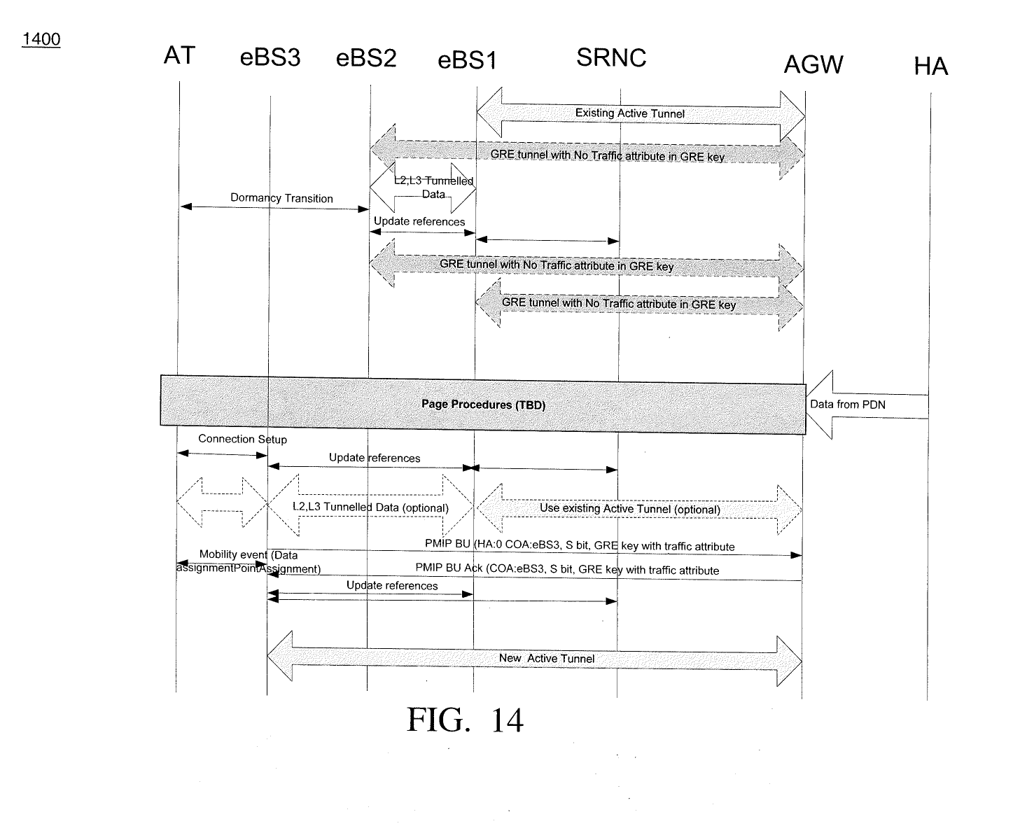

Specific embodiments of the present invention are disclosed below with reference to FIGS. 1-15. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the signaling flow diagrams and/or the logic flow diagrams above are described and shown with reference to specific signaling exchanged and/or specific functionality performed in a specific order, some of the signaling/functionality may be omitted or some of the signaling/functionality may be combined, sub-divided, or reordered without departing from the scope of the claims. Thus, unless specifically indicated, the order and grouping of the signaling/functionality depicted is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### DETAILED DESCRIPTION OF EMBODIMENTS

Various embodiments are described, some of which may be able to better support real-time services during mobility events in communication networks. In general in these embodiments, multiple tunnels are established via different network nodes within the communication network to support data transfer in both a forward direction to an access terminal (AT) and a reverse direction from the AT. Data transfer in the forward direction is supported for a period of time via a first tunnel of the multiple tunnels, while data transfer in the reverse direction is supported via a second, different tunnel during the same period of time.

The disclosed embodiments can be more fully understood with reference to FIGS. 1-15. FIG. 1 is a messaging flow diagram 100 depicting the use of multiple tunnels, in accordance with various embodiments of the present invention. At present, standards bodies such as OMA (Open Mobile Alliance), 3GPP (3rd Generation Partnership Project), 3GPP2 (3rd Generation Partnership Project 2), IEEE (Institute of Electrical and Electronics Engineers) 802, and WiMAX Forum are developing standards specifications for wireless telecommunications systems. (These groups may be contacted via http://www.openmobilealliance.com, http://www.3gpp.org/, http://www.3gpp2.com/, http://www.ieee802.org/, and http://www.wimaxforum.org/respectively.) Messaging flow diagram 100 generally depicts network nodes 1-3 as messaging endpoints. The communication network represented by network nodes 1-3 is a system having an architecture in accordance with any one or more of the 3GPP2, 3GPP, WiMAX Forum and/or IEEE 802 technologies, suitably modified to implement the present invention.

Network nodes 1-3 are depicted in a very generalized manner. Those skilled in the art will recognize that FIG. 1 does not depict all of the physical fixed network components that may be necessary for the communication network to operate but only those system components and logical entities particularly relevant to the description of embodiments herein. For example, although not shown network nodes 1 and 3 provide network service to access terminals (ATs) using wireless interfaces. The wireless interfaces used are in accordance with the particular access technology supported by each respective network node. For example, they may all utilize the same technology such as one based on 3GPP2 specifications or IEEE 802.16, or they may utilize different access technologies.

Also, FIG. 1 does not depict that network nodes 1-3 each comprise processing units and network interfaces. Additionally, network nodes 1 and 3 each comprise wireless transceivers. In general, components such as processing units, transceivers and network interfaces are well-known. For example, processing units are known to comprise basic components such as, but neither limited to nor necessarily requiring, microprocessors, microcontrollers, memory devices, application-specific integrated circuits (ASICs), and/or logic circuitry. Such components are typically adapted to implement algorithms and/or protocols that have been expressed using high-level design languages or descriptions, expressed using computer instructions, expressed using signaling/messaging flow diagrams, and/or expressed using logic flow diagrams.

Thus, given a high-level description, an algorithm, a logic flow, a messaging/signaling flow, and/or a protocol specification, those skilled in the art are aware of the many design and development techniques available to implement a processing unit that performs the given logic. Therefore, network nodes 1-3 represent known devices that have been adapted, in accordance with the description herein, to implement multiple embodiments of the present invention. Furthermore, those skilled in the art will recognize that aspects of the present invention may be implemented in or across various physical components and none are necessarily limited to single platform implementations. For example, a network node may be implemented in or across one or more communication network components, such as a base transceiver station (BTS), a base station controller (BSC), a base station (BS) (e.g., an enhanced BS (eBS)), a Node-B, a radio network controller (RNC) (e.g., a signaling RNC (sRNC)), an HRPD access network (AN), HRPD packet control function (PCF), an access service network (ASN) gateway, an access gateway (AGW), an ASN base station, an access point (AP), a wideband base station (WBS), and/or a WLAN (wireless local area network) station.

Access terminals (ATs), mobile devices, remote units, subscriber stations (SSs) and/or user equipment (UEs), may be thought of as mobile stations (MSs), mobile subscriber stations (MSSs) or mobile nodes (MNs). In addition, AT platforms are known to refer to a wide variety of consumer electronic platforms such as, but not limited to, mobile stations (MSs), terminal equipment, remote units, gaming devices, personal computers, and personal digital assistants (PDAs). In particular, ATs each comprise a processing unit and transceiver. Depending on the embodiment, each AT may additionally comprise a keypad, a speaker, a microphone, and a display. Processing units, transceivers, keypads, speakers, microphones, and displays as used in ATs are all well-known in the art.

Operation of embodiments in accordance with the present invention occurs substantially as follows, first with reference to FIG. 1. As depicted in FIG. 1, network node 2 and network node 3 have a tunnel 110 to support data transfer for an AT. For purposes of illustration, network node 3 is assumed to be a serving node for the AT and tunnel 110 is assumed to be active, being used to support data transfer in both a forward direction to the AT and a reverse direction from the AT.

At some point, network node 1 sends messaging 120 to network node 2 to establish a tunnel between network node 1 and network node 2. Depending on the embodiment and the situation at hand, many events might cause network node 1 to send messaging 120. For example, network node 1 may do so in response to receiving an indication that it has been added to the active set of the AT or that the AT wishes to handoff to network node 1. Alternatively, for example, the communication network may be anticipating that the AT will handoff to network node 1 shortly, or the communication network may be setting up tunnels based on the possibility that the AT could handoff to network node 1 in the near future.

The type of messaging actually sent is highly dependent on the embodiment. For example, messaging 120 may comprise a PMIP (Proxy Mobile Internet Protocol) message to establish a PMIP tunnel, such as a PMIP BU (binding update) message. This or some other message may also indicate whether the tunnel will now begin to be used to support data transfer in either the reverse or the forward direction. For example, a parameter may simply indicate this or perhaps bits corresponding to the forward and reverse directions within a parameter such as a generic route encapsulation (GRE) key may be used.

For purposes of illustration, it is assumed that messaging 120 indicated that the tunnel will not begin to be used to support data transfer in either the reverse or the forward direction. Thus, new tunnel 130 remains inactive initially. However, an event such as network node 1 becoming a serving network node for the AT may cause the new tunnel to become active as tunnel 160. For example, network node 1 may send messaging to network node 2 that indicates that the new tunnel will be used to support data transfer in the reverse direction. This messaging may take the form of an indication in a GRE header of a message sent via tunnel 160, perhaps in a message with reverse direction data. In alternative embodiments, network node 1 may instead receive messaging that indicates that the new tunnel will be used to support data transfer in the reverse direction.

The previous active tunnel 140 and tunnel 150 may be used to support data in the forward direction to the AT. Thus, for a period of time different tunnels are used for supporting AT data transfer depending on the data direction. Messaging may then be sent (or received by network node 1), perhaps via tunnel 170, indicating that the new tunnel would now be used for data in both directions to/from the AT.

While FIG. 1 more generally depicts functional aspects of various embodiments of the present invention, it is believed that a more detailed description of particular embodiments will assist the reader in understanding and implementing the more generically described embodiments above. The embodiments described below are provided as examples. They are provided as particular, and quite specific, example embodiments of the present invention. They are intended to further the reader's understanding of the variety of possible embodiments rather than to limit the scope of the invention.

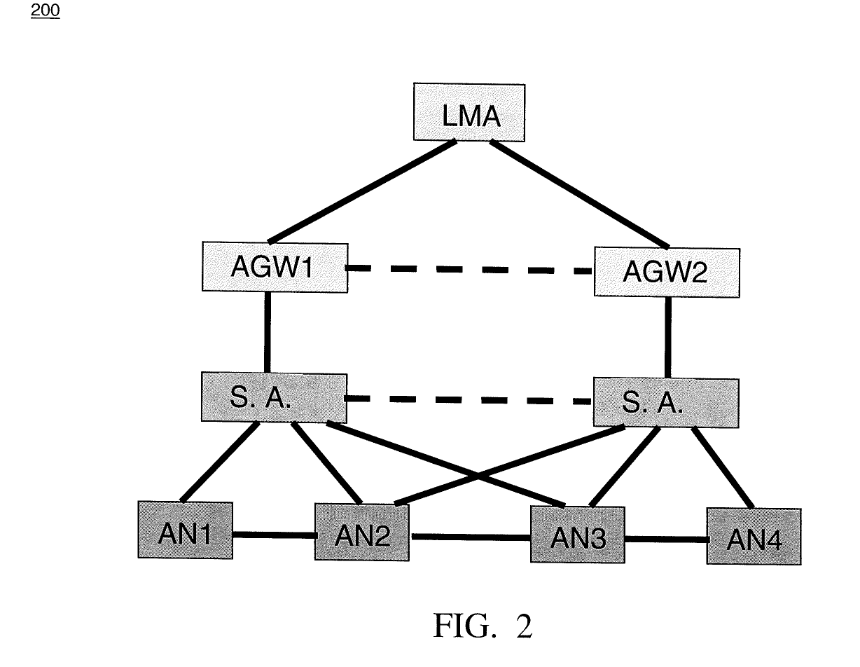

FIGS. 2-6 are block diagrams depiction of possible tunneling structures between functional elements in wireless communication systems, in accordance with more specific embodiments of the present invention. As diagrams 200, 300, 400, 500, and 600 show many data anchors and tunnels may be set up across different functional elements in a wireless communication system. For example, an eBS, a mobile telephone switching office (MTSO)/MSC (Mobile Switching Center), an RNC, an AGW, and/or a local mobility anchor (LMA) may all serve as data anchors. Some notes with respect to diagram 200 follow:
Extend Session Anchor Route beyond just between AT and eBS.
Session Anchor can be sRNC itself or assigned by sRNC other than eBS.
Each AN is configured or signaled to set up an SA route for AT.
The SA route stays the same within the entire configured range.
Each AN may access >1 SA.

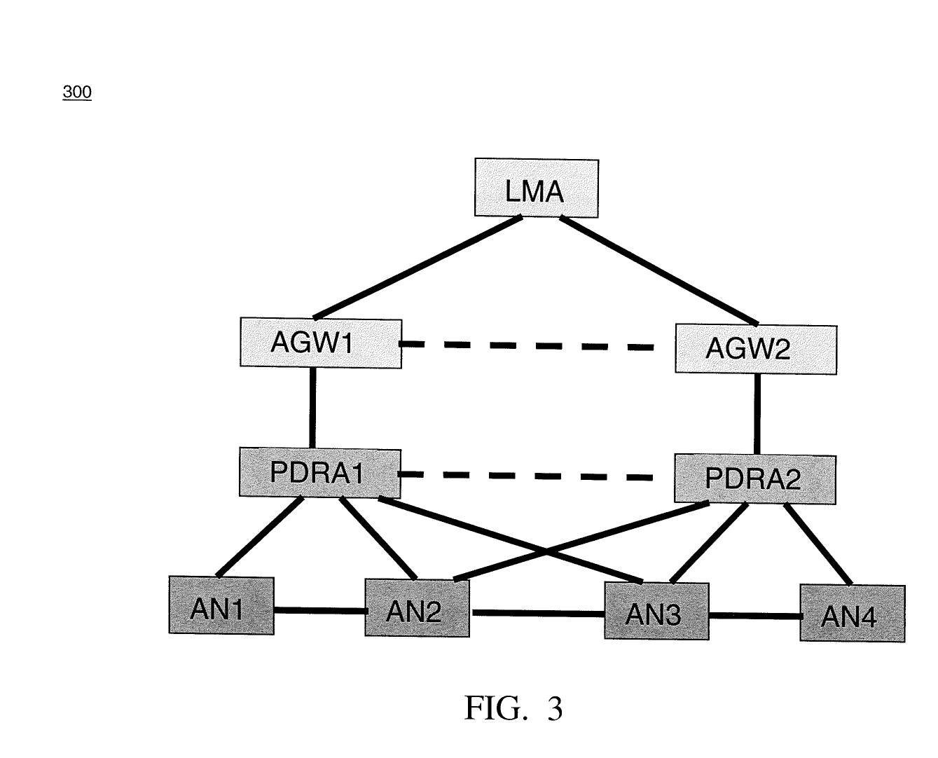

Some notes with respect to FIGS. 3-6 follow:
Each proxy data route anchor (PDRA) may not have all the protocol stack (Route Control Protocol) to serve as data anchor as proposed by the standard. The data anchor routes are created by the serving eBS and recognizable by eBS's via assigned “Anchor” Route ID or IP.
Multiple proxy data tunnels, between the PDRA and AGW, are allowed to be pre-setup for fast inter-eBS handoffs and for anchor handoffs.
Data Anchor handoff can be initiated by either an SRNC or between eBSs.
PDRA/DAP may be part of AN itself.

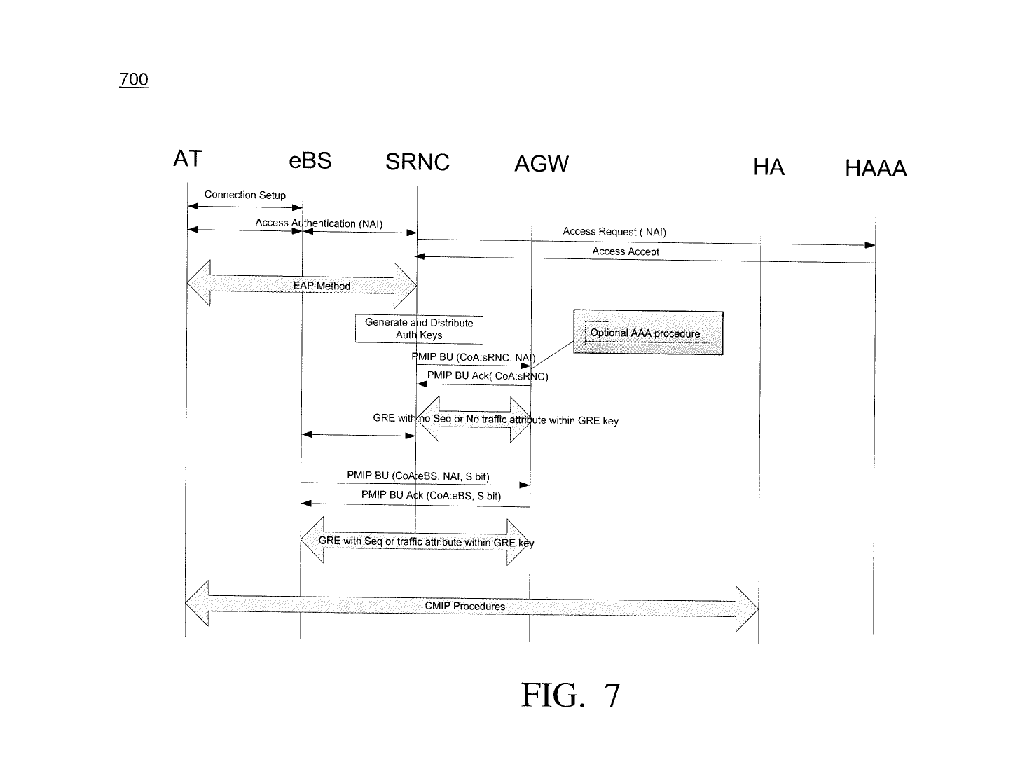

Before discussing FIGS. 7-15 in detail, some preface material may be useful. Described herein is the concept of a proxy route that will allow an eBS which is not in direct RF contact with the AT to have a route created by another eBS which is in the active set and be maintained by any active eBS in the same subnet or a group of subnets. It is also described that such routes can be anchor routes to connect to the network Access Gateway (AGW). Additionally, a list of these anchor routes may be created and maintained by anchors and ATs and with serving anchors indicated in the list. The AT can then select the serving anchor when it moves within the network from eBS to eBS. Additionally, more than one anchor route is allowed. The anchor routes can be added to the AT's anchor list before they become the serving routes. Anchor negotiation and context transfer may be performed before anchor handoff.

Each eBS should be capable of creating routes for the session anchors and data anchors. The eBS is capable of creating and maintaining multiple routes and a session anchor. The eBS is also capable of receiving the requests from other eBS to create, maintain and deactivate the anchor routes. Each eBS maintains at least one set of tunnels to communicate with the session and data anchor(s).

When the anchor is separated from the AGW, it will perform the establishment of the data tunnel on behalf of the AT either through an interface similar to A10/A11 of the 3GPP2 specification, or by a single tunnel as specified by IETF protocols. When an AT has access to multiple serving eBSs, each one of them can serve as the access point to the AGW. Multiple tunnels can be established between these eBSs with the AGW. AT can utilize each of the data tunnels for reverse traffic to the same AGW. The tunnel for forward traffic can be turned on or off based on the actual connection between the anchor and AT.

This allows additional tunnels, in particular those used by the session and data anchor(s), to be created and maintained even when they are not in direct RF contact with the AT. That is, this will prevent the serving anchor (eBS) from having to be handed off to another anchor due to the limitation of the size of the active set that the AT can maintain. This will further allow the eBS that is not in the active set to serve as the anchor.

With these additional capabilities, the following benefits can be achieved:

Flexibility of the anchor location which can be the switch site or anywhere in the network

Reduced the need for anchor handoffs

Reduced inter-eBS traffic

Reduced backhaul capacity needs by avoiding the user and signaling traffic having to trombone back and forth over the spoke backhaul when the anchor is located where the current BTS is and

Avoid extra latency due to the traffic tromboning over the backhaul.

Embodiments described below are applicable to an Access Gateway to eBS/sRNC interface framework for an evolution of the current 3GPP2 HRPD packet data network to an optimized solution that can better support real time services such as VoIP, Video Telephony, voice and video streaming, etc. The proposed framework can be used across multiple access technologies including the UMB air interface currently being developed in 3GPP2. Specifically the descriptions below are applicable to a high level interface architecture based on Proxy Mobile IP for an interface between the Access network and the Gateway.

The main goal behind this proposal is to minimize the amount of signaling sent to the AGW due to air interface transitions and events and thereby reducing the latency in setting up bearer paths within the network. This proposal allows for pre-setting up PMIP tunnels which would provide an efficient method for switching between active/dormant transitions or Data anchor re-assignments in the case of mobility. This proposal allows for simultaneous PMIP bindings for the same AT to be pre-established towards the AGW from the access network, for example, sRNC, Anchor eBS (Data Assignment Point) and serving eBSs. At any instance of time, there can be only one active tunnel in any direction of the tunnel. Tunnel context is switched to either sRNC/eBS (during dormancy transitions) or to another serving eBS (DAP re-assignment) without the need for explicit PMIP or control signaling. Tunnel contexts are switched based on certain attributes of the GRE header along with the payload.

Some assumptions include the following:
Use of PMIP signaling and GRE compliant with RFC 1701 for bearer transport
Only one active Data Anchor at any given time for both forward and reverse traffic to AGW
GRE packets without payload can be sent.
AGW will allow multiple simultaneous binding for a single AT.
Key or Sequence number in GRE will have 3GPP2 specific bit fields.

Some more general notes regarding many of the embodiments described below include the following:
A data anchor route is chosen based on the active set change, to ensure lower latency and data loss.
The serving BS will be able to signal to the data anchor to turn on the tunnel. The data anchor does not bi-cast/simulcast the traffic.
Data anchor will be able to receive the reverse link data over the route even before the forward link.
Having multiple tunnels allows data to be sent to session anchors (e.g., sRNC) during dormancy if needed.

FIGS. 7-14 are messaging flow diagrams depicting the use of multiple tunnels, in accordance with more specific embodiments of the present invention. Flow diagram 700 illustrates at a high level the PMIP context establishment procedure towards the AGW. The sRNC will use the NAI from EAP procedures performed as part of Access authentication to establish a PMIP tunnel. The sRNC may indicate to the AGW that the tunnel is still inactive by sending an empty GRE packet with sequence number of 0 or with a field within the GRE key set to 0 (for this proposal called the traffic attribute). Subsequently, when the anchor eBS establishes another PMIP tunnel binding with the simulcast (S) bit set, then, the anchor eBS having the bearer will send GRE packets to the AGW with a non zero sequence number or traffic attribute in the GRE key set certain value.

The method of indicating the active bearer tunnel to the AGW can be with a presence of non-zero sequence number or a non-zero field within the GRE key from either the eBS or the sRNC. In call flow 700, the eBS is indicating that the active tunnel peer via the presence of such sequence number or without a traffic attribute field within the GRE key. The sRNC/AGW would not send any GRE packet to the other peer if there is no traffic attribute or the sequence number is set to 0.

Flow diagram 800 illustrates at a high level the PMIP context establishment procedure towards the AGW. The eBS will use the NAI from EAP procedures performed as part of Access or Subscription authentication to establish a PMIP tunnel. The eBS may indicate to the AGW that the tunnel is inactive by sending an empty GRE packet with sequence number of 0 or with a field within the GRE key set to 0 (for this proposal called the traffic attribute). (NOTE: This attribute is proposed as an example GRE header modification with the intention of minimizing the 3GPP2 specific fields in the GRE header.) Subsequently, when additional eBS establishes another PMIP tunnel binding with the simulcast (S) bit set, then, those eBSs will send GRE packets with/without payload to the AGW with traffic attribute in the GRE key set to 0 value. Even though the length GRE key gets reduced, the total unique GRE keys per tunnel will still be a large.

The method of indicating the active bearer tunnel to the AGW can be with a presence of a non-zero traffic attribute field within the GRE key from the eBS. In call flow 800, the eBS is indicating that the active tunnel peer via the traffic attribute field within the GRE key. The AGW would not send any GRE packet to the other peer (ie, in the other direction) if there is no traffic attribute.

Impacts of Active set changes to eBSs are indicated below. This illustrates all eBSs including non-data anchor eBS establishing the PMIP tunnels with simultaneous bindings. When the network switches the data anchors based on certain triggers outside the scope of this document, the new anchor may indicate the switch to the AGW with the traffic attribute of the GRE key or with a valid sequence number.

This proposal provides one of the quickest alternative methods for serving eBS to send/receive data directly from the AGW (becoming an Anchor). In flow diagram 900, deleting the current Anchor eBS from the active set is coinciding with a DataAnchor movement to a new serving eBS. However, deleting the anchor eBS from the active set need not always result in the Anchor point movement to the new serving eBS. This proposal clearly identifies the association between an Anchor eBS (DAP) and the active GRE tunnel.

This mechanism of pre-setup may provide an efficient method for sending data from a new eBS in the reverse direction without adding additional latency and without additional 3GPP2-specific signaling. It also allows for bearer transfer to/from the new data anchor to the FLSA (Forward link serving AN) and RLSA (Reverse link serving AN).

Alternative impacts of Active set changes to eBSs are indicated below. This illustrates all eBSs including non-data anchor eBS establishing the PMIP tunnels with simultaneous bindings. Flow diagram 1000 illustrates a scenario where the data is still routed through the DAP even after the DAP is removed from the active set. The network can still anchor the DAP functionality even though the AT has moved to the new serving eBS. When the network switches the data anchors based on certain triggers outside the scope of this document, the new anchor may indicate the switch to the AGW with the traffic attribute of the GRE key. In flow diagram 1000, deleting the anchor eBS from the active set need not always result in the Anchor point movement to the new serving eBS. This proposal clearly identifies the association between an Anchor eBS (DAP) and the active GRE tunnel.

The following proposal provides one of the quickest alternative methods for serving eBS to send data directly to the AGW and subsequently receive data from the AGW (becoming an Anchor). In flow diagram 1100, the current Data Anchor is moved to a new serving eBS by sending the data directly to AGW. The AGW can also potentially switch the forward tunnel by sending a non-zero traffic attribute in the GRE key with/without payload to the new serving eBS without extensive signaling. This can also be used to trigger the DAP movement to the AT, if not already performed.

This mechanism of pre-setup, when the active set gets added, may provide an efficient method for sending data from a new eBS in the reverse direction without adding additional latency and without additional 3GPP2-specific signaling. It also allows for bearer transfer to/from the new data anchor to the FLSA and RLSA.

Impacts to eBS, sRNC and AGW for dormacy transitions are illustrated below in flow diagram 1200. All eBSes including non-data anchor eBS will maintain the PMIP tunnels with simultaneous bindings. Tunnel maintainance or Ack procedures from the receipient can use empty GRE packet without traffic attribute in GRE key or Sequence number of 0. Transitioning between the active data anchor and sRNC during dormacy uses already presetup PMIP tunnels with a Traffic field within the GRE key indication or Sequence number without additional signaling. In case of dormant to Active transition, the data anchor point (anchor eBS) or Serving eBS can send data directly to the AGW. This method will reduce the latency and increases the efficiency on sidehauls. The method of pre-establishing data paths to/from sRNC/eBS of the active set also helps with reliability and availability issues of data anchor eBS.

Alternative impacts to eBS and AGW for dormancy transitions are illustrated below in flow diagram 1300. All eBSs including non-data anchor eBS will maintain the PMIP tunnels with simultaneous bindings. Tunnel maintenance or Ack procedures from the recipient can use empty GRE packet without traffic attribute in GRE key. The following scenario shows when the AT has not moved out of the DAP coverage with other potential FLSA/RLSA members when the AT reactivates due to a page trigger. (Note: The traffic attributes can also serve the purpose of flow control towards the AGW during dormancy transition if page buffering is performed in the AGW (FFS).)

Scenario below in flow diagram 1400 illustrates AT moving to the new eBS that has not established the PMIP tunnels. In case of dormant to Active transition, the data anchor point (anchor eBS) or serving eBS can send data directly to the AGW and move the data anchor point. This method of establishing data paths to/from eBS also helps with reliability and availability issues of data anchor eBS. (Note: The above PMIP/GRE method can be extended to the sRNC-AGW interface for dormancy and page buffering during reactivation is required in the sRNC. The signaling messages are FFS.)

Some advantages possible in view of at least some of the embodiments above include:

Reducing network signaling delay

Facilitating Inter-technology handoff by reducing 3GPP2 specific signaling

Reducing bearer latency

Potential for increase in side haul efficiency by decreasing the inter-eBS traffic

Less dependence on DAP availability.

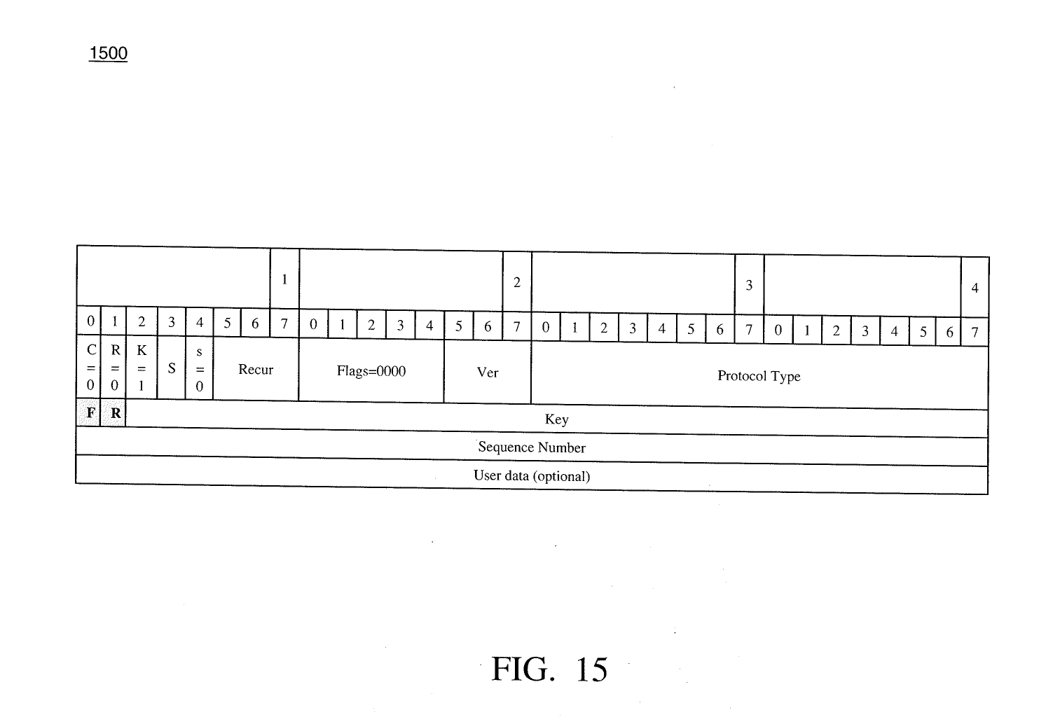

FIG. 15 is a block diagram depiction of a GRE header with modified key field, in accordance with more specific embodiments of the present invention. The F and R fields are the traffic attributes per direction of traffic (F for forward, R for reverse). The eBS can set both F and R bits in order to move tunnel in both directions; however, the AGW should only set the F bit after the eBS has established the PMIP tunnel.

One of skill in the art will appreciate that various modifications and changes may be made to the specific embodiments described above with respect to FIGS. 1-15 without departing from the spirit and scope of the present invention. Thus, the discussion of certain embodiments in greater detail above (FIGS. 2-15) is to be regarded as illustrative and exemplary rather than restrictive or all-encompassing, and all such modifications to the specific embodiments described above are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, and the like, are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the information or object being indicated. Some, but not all examples of techniques available for communicating or referencing the information or object being indicated include the conveyance of the information or object being indicated, the conveyance of an identifier of the information or object being indicated, the conveyance of information used to generate the information or object being indicated, the conveyance of some part or portion of the information or object being indicated, the conveyance of some derivation of the information or object being indicated, and the conveyance of some symbol representing the information or object being indicated. The terms program, computer program, and computer instructions, as used herein, are defined as a sequence of instructions designed for execution on a computer system. This sequence of instructions may include, but is not limited to, a subroutine, a function, a procedure, an object method, an object implementation, an executable application, an applet, a servlet, a shared library/dynamic load library, a source code, an object code and/or an assembly code.

What is claimed is:

1. A method for using multiple tunnels within a communication network comprising:
establishing multiple tunnels via different network nodes within the communication network to support data transfer in both a forward direction to an access terminal (AT) and a reverse direction from the AT;
supporting the data transfer in the forward direction for a period of time via a first tunnel of the multiple tunnels;
supporting the data transfer in the reverse direction for the same period of time via a second tunnel of the multiple tunnels, wherein the first tunnel is different than the second tunnel.

2. The method of claim 1, further comprising
supporting the data transfer in the reverse direction for the same period of time additionally via the first tunnel.

3. The method of claim 1, wherein supporting the data transfer in the forward direction for the period of time via the first tunnel comprises supporting the data transfer in the forward direction for the period of time only via the first tunnel.

4. The method of claim 1, wherein supporting the data transfer in the reverse direction for the same period of time via the second tunnel comprises supporting the data transfer in the reverse direction for the same period of time only via the second tunnel.

5. The method of claim 1, further comprising
at the end of the period of time, switching support of the data transfer in the forward direction from the first tunnel to the second tunnel.

6. The method of claim 1, further comprising
at the end of the period of time, switching support of the data transfer in the reverse direction from the second tunnel to the first tunnel.

7. A method for using multiple tunnels within a communication network comprising:
sending messaging by a first network node to a second network node to establish a first tunnel between the first network node and the second network node to support data transfer for an access terminal (AT), the second network node also having a second tunnel with a third network node to support data transfer for the AT;
supporting data transfer in one of a reverse direction from the AT and a forward direction to the AT, but not in the other direction, for a period of time via the first tunnel;
subsequent to the period of time, supporting data transfer in both the reverse direction from the AT and the forward direction to the AT via the first tunnel.

8. The method of claim 7, wherein sending messaging to establish the first tunnel comprises
sending messaging to establish the first tunnel in response to receiving an indication that the first network node had been added to the active set of the AT.

9. The method of claim 7, wherein sending messaging to establish the first tunnel comprises
indicating whether the first tunnel will now begin to be used to support data transfer in at least one of the reverse and the forward directions.

10. The method of claim 9, wherein sending messaging to establish the first tunnel comprises
sending a PMIP (Proxy Mobile Internet Protocol) message to establish a PMIP tunnel.

11. The method of claim 7, further comprising
sending messaging by the first network node to the second network node that indicates that the first tunnel will be used to support data transfer in at least one of the reverse and the forward directions.

12. The method of claim 11, wherein sending messaging that indicates that the first tunnel will be used to support data transfer in at least one of the reverse and the forward directions comprises
indicating in a generic route encapsulation (GRE) header in which directions the first tunnel will be used to support data transfer.

13. The method of claim 11, wherein sending messaging that indicates that the first tunnel will be used to support data transfer in at least one of the reverse and the forward directions comprises
sending the messaging via the first tunnel.

14. The method of claim 11, wherein sending messaging that indicates that the first tunnel will be used to support data transfer in at least one of the reverse and the forward directions comprises
sending messaging that indicates that the first tunnel will be used in response to the first network node becoming a serving node of the AT.

15. The method of claim 7, further comprising
receiving messaging by the first network node that indicates that the first tunnel will be used to support data transfer in at least one of the reverse and the forward directions.

16. The method of claim 15, wherein receiving messaging that indicates that the first tunnel will be used to support data transfer in at least one of the reverse and the forward directions comprises
receiving the messaging via the first tunnel.
